(19) United States
(12) Patent Application Publication
(10) Pub. No.: US 2024/0342577 A1
(43) Pub. Date: Oct. 17, 2024

(54) USER INTERFACE DEVICE AND METHOD THEREOF FOR GAME MANAGEMENT

(71) Applicant: Modern Football Inc., Rocklin, CA (US)

(72) Inventor: Christian Masegian, Rocklin, CA (US)

(21) Appl. No.: 18/633,134

(22) Filed: Apr. 11, 2024

Related U.S. Application Data
(63) Continuation of application No. PCT/US24/12474, filed on Jan. 22, 2024.
(60) Provisional application No. 63/440,372, filed on Jan. 20, 2023.

(51) Int. Cl. A63B 71/06

(52) U.S. Cl. CPC A63B 71/0616; A63B 71/0669; A63B 2243/0025; A63B 2243/0037; A63B 2243/007

(57) ABSTRACT

A user interface device is configured to generate, for a user managing a user's team during a course of a game, a user interface that includes a plurality of regions, the plurality of regions including one or more regions to enable a user to specify one of a play call or a scheme. The user interface includes a dynamic panel that overlays one or more of the plurality of regions. Further, the user interface includes a dynamic panel that displays team-specific analytic information that is updated responsively to game events that affect the analytic information. The user interface device generates a recommendation output on the dynamic panel, the recommendation output identifying one or more of a candidate set of play calls or defensive schemes.

### RELATED APPLICATIONS

This application is a continuation of PCT/US24/12474, filed Jan. 22, 2024, which claims the benefit of priority to Provisional U.S. Patent Application No. 63/440,372, filed Jan. 20, 2023; the aforementioned priority application being hereby incorporated by reference in its entirety.

### BACKGROUND OF THE INVENTION

The rules of an American football game are well known. During the course of a game, each team has an opportunity to act on offense to advance a football to an opposing team's end zone. The offensive opportunity can be in the form of a series of downs, where each down corresponds to a time interval that begins when the ball is put in play and ends when the ball is declared dead. When a team starts on offense, a team has a series of four downs to advance the ball ten yards. If the team is able to advance the ball ten yards, the downs start over again. In between downs, the offensive team is provided with a play clock (e.g., 25 seconds, 40 seconds etc.). In the time allotted by the play clock, each team can put in players, specify initial player positioning, timing under which individual users are to perform actions when the down initiates, and specifics of actions which individual players are to perform.

On defense, a team typically uses the play clock interval to arrange a defensive scheme to run during a down. For example, defensive players for the down can be selected and assigned positions on the field. Further, individual players can be assigned actions to perform once the down starts. In a defensive scheme, select players may charge the quarterback of the opposing team (e.g., “blitz”), and such blitzes may optionally be delayed or responsive to conditions which may occur in the initial seconds of a played down.

On offense, a team can use the play clock to select a play to run during the down. The offensive play designates offensive players that are to play during the down, as well as initial positioning of the offensive players before the down starts. Further, the offensive plays can specify actions individual users may perform during the down (e.g., handoff to running-back, route run by a receiver, blocking scheme, etc.).

In game play, coaches, assistant coaches or other individuals with roles of managing game play make decisions in the limited time afforded by the play clock.

### BRIEF DESCRIPTION OF DRAWINGS

FIG. 1A illustrates a user interface device for game management system, according to one or more embodiments;

FIG. 1B illustrates a recommendation engine for use with the user interface device, according to one or more embodiments;

FIG. 2A and FIG. 2B illustrates a first example of a user interface, according to one or more embodiments;

FIG. 2C illustrates a second example of user interface, according to one or more examples;

FIG. 2D illustrates another user interface for game management, according to one or more embodiments;

FIG. 3A illustrates a method for using a user interface device for game management during the course of a game, according to one or more embodiments;

FIG. 3B illustrates a method for implementing a recommendation engine in the course of a game, according to one or more embodiments; and

FIG. 4 illustrates a computing device or system on which one or more embodiments can be implemented.

### DETAILED DESCRIPTION

Embodiments provide a game management system and device that is optimized for enabling a user to record information about a game as it occurs, and further to perform tasks for play calling.

There are currently limited resources available for such users to leverage technology in context of making play calls and managing games. This is in part due to the highly dynamic environment where games are played. At higher levels of the game, assistant coaches (or coaching assistances) can operate computers (e.g., laptops, tablets) in connection with tasks which they may perform, at many levels, there are only a few coaching personnel who work the sideline viewing the game, communicating with players and performing game management tasks. For such environments, in the computing resource to facilitate game management tasks would need to be mobile.

Moreover, the performance of game management tasks often require the coaching staff to record information, such as situational information (e.g., down and yardage), the play called (which can include a relatively large number of dimensions representing configurations that are selected on-the-fly), the defensive scheme deployed (which can also include a relatively large number of variables representing configurations implemented by the opposing team), and outcomes of play calls. A conventional resource such as a spreadsheet would be of no use in such dynamic environment, as the number information items which a user has to specify at each down (e.g., situational information, play call with multitude of configurations, defensive scheme with multitude of dimensions, outcome variables, etc.) would simply require too many user interaction, particularly for the limited time that is afforded to the user to enter such information. For example, if each information item had its own set of columns on a spreadsheet, a user would likely need to specify values for more than 30 columns, likely using a keyboard-first to specify play selection (with various configurations and permutations, including personnel selection, etc.), and second to record events such the defensive scheme (e.g., with permutations and personnel), situational information and outcomes. Conventional user interface features such as drop-down menus would also be of limited use by themselves, because such features require the user to scroll and select.

Examples provide for a computing device that is configured to provide a user interface that enables the user to specify a relatively large number of information items (with multitude dimensions) in just few seconds. Further, the user interface can be dynamically configured for situational events (e.g. downs) as they arise, such that the user interface includes situation-specific optimizations that further facilitate user interaction and game management.

Still further, some examples can be implemented as an application that executes on a tablet to transform the tablet into a specialized device for recording in game information and performing other game management tasks. When implemented as a specialized user interface device, examples enable users to specify a large number of selectable information items at each play calling event (e.g., down) with just a fraction (e.g., less than 30%) of a number of touches. For example, a user can specify 30 or more information items relating to the tasks of play calling and event recording, in fewer than 10 touches.

Further, as described, a user interface device can be optimized in its configuration to enable tasks to be performed in accordance with flows that match events as they unfold, further reducing the number of user touches and time allotment for performing the tasks.

Still further, examples provide for a user interface device that is configured to generate, for a user managing a user's team during a course of a game, a user interface that includes a plurality of regions, the plurality of regions including one or more regions to enable a user to specify one of a play call or a scheme. The user interface includes a dynamic panel that overlays one or more of the plurality of regions. Further, the user interface includes a dynamic panel that displays team-specific analytic information that is updated responsively to game events that affect the analytic information. The user interface device generates a recommendation output on the dynamic panel, the recommendation output identifying one or more of a candidate set of play calls or defensive schemes.

As used herein, a client device refers to devices corresponding to desktop computers, cellular devices or smartphones, wearable devices, laptop computers, tablet devices, television (IP Television), etc., that can provide network connectivity and processing resources for communicating with the system over a network.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

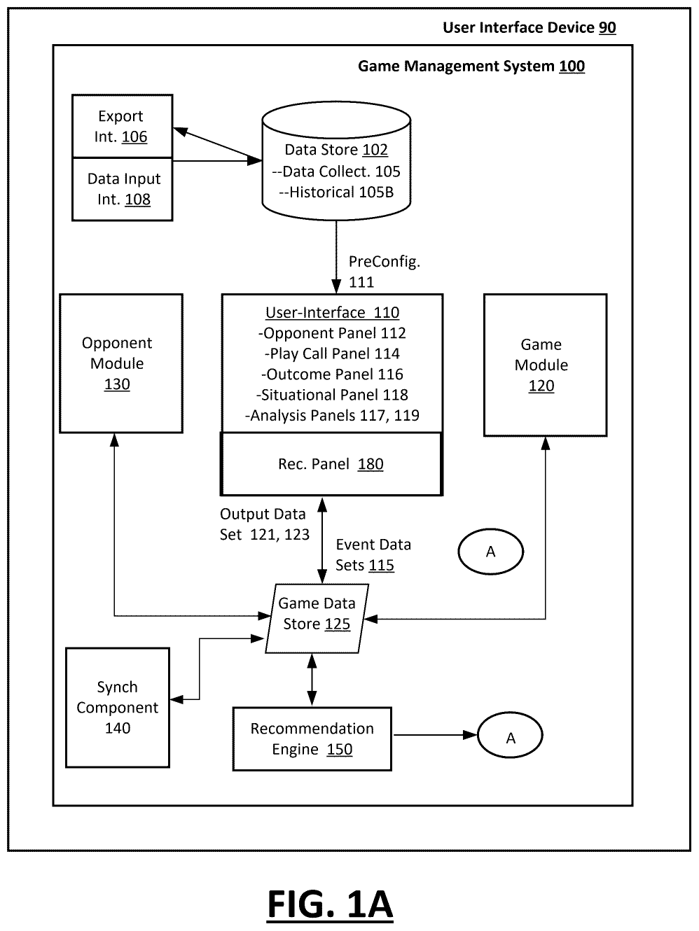

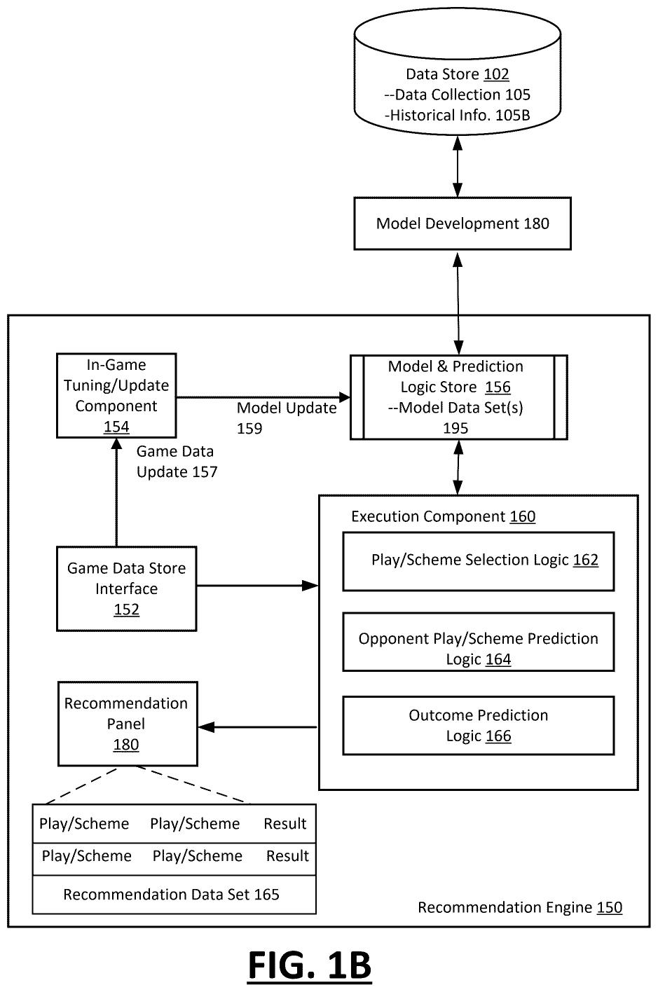

FIG. 1A illustrates a game management system, according to one or more embodiments. In examples as described, a game management system 100 can be implemented on a computing device, or combination of computing devices. In some examples, the game management system 100 can be implemented as an application that runs on a user computing device, such as a touch-sensitive computing device (e.g., tablet). For example, the user can download an application (e.g., from an app store) onto a tablet device, then implement the game management system by executing the application game management system 100. In variations, the system 100 is distributed or otherwise implemented on multiple computing devices or environments (e.g., multiple tablets, tablet and server, etc.). For example, the game management system 100 can be distributed on a network computer system, and/or between the user computing device and/or a network computer (e.g., server(s)) or cloud computing platform.

While numerous examples are described in context of a touch-sensitive device, in variations, alternative computing devices and environments may be employed. For example, the game management system 100 can be implemented on a computing device that utilizes voice-recognition and/or keypad entry, rather than touch.

According to some examples, the game management system 100 and user interface device 90 can be operated by one or more users in order to manage an American Football game. In variations, the game management system 100 and user interface device 90 can be configured for use in similar types of contact sports, such as Australian Football and rugby. Still further, the game management system 100 and user interface device 90 can be configured for use in different types of sports (e.g., basketball and soccer). Accordingly, while examples are described in context of American football, embodiments and aspects thereof can be applied to other types of sporting events.

In examples, the user can correspond to, for example, a coach, assistance coach or any other individual that has a role with recording events (e.g., plays) and selecting plays during the course of a game. Examples recognize that in the course of a game, a user (or users) having roles of game management have limited time to call offensive plays. Typically, the amount of time for performing the game management tasks is a fraction of the play clock, as the play call may require substitution of players, communication of play calls to players, etc. In that limited time, a user has to perform tasks (“game management tasks”) that include selecting an offensive play (alternatively referred to as “play calling”) for their team to run (e.g., offensive plays), where the selected plays are specific to a game situation (e.g., down, yards to first down or end-zone, etc.). Typically, the user has 5 to 15 seconds to make a play call. When the user's team is playing an up-tempo offensive, it is also desirable for the play calls to be made as soon as possible (e.g., 5 seconds or less).

To be effective, the play calling may take into account prior events, such as prior plays the user's team ran, the outcome of such plays, the defensive alignment the plays faced, and other factors. Additionally, teams often have game plans, where they select types of offensive plays, configurations, and personnel to run, in particular situations. When a game plan is effective, the defense of the other team makes adjustments, and the effectiveness of the individual play calling may decrease. Thus, there is often a need to track the results of individual plays which are called on downs in order to determine whether a team's game plan is effective, and also to detect when defensive adjustments are effective. To meet this objective, the game management tasks of the user typically include recording situation-specific information about events that occur during the course of a game, and more specifically, recording (i) information about the defensive configuration which was run against the team on a given down, (ii) information about the play that is called (e.g., specific play called, lateral position on field, personnel used, etc.), (iii) situational information with respect to each play call (e.g., down and yardage), and (iv) the outcome of plays run on specific downs.

In this way, the game management tasks of the user include play selection and recording information about the plays, including the defensive configuration and the outcome. As mentioned, the game management tasks have to be performed within seconds for the user to be effective. The time pressure can particularly affect the ability of the user to make selections of plays. For example, if the user changes their mind as to the play call, there may be insufficient time on the field to start the play on down. Further, the fast movement of the game, combined with the time pressure can make it difficult for the user to implement a desired game plan, or to respond to a defensive game plan or adjustment of the opponent. Additionally, the permutations which exist with respect to events that occur during downs (e.g., situational information, defensive scheme and variations) and play calling (e.g., number of offensive plays and permutations number in hundreds) complicate the decision making and performance of the game management tasks.

Among other advantages, game management system 100 provides an interface that is optimized for enabling real-time data entry about events (e.g., situation information, defensive schemes) run by the opposing team. The interface can be constructed in accordance with a workflow such that the game management tasks of recording information is done in a minimal amount of time. In some examples, the optimizations includes configurations which the game management system 100 implements to minimize a number of interactions which a user may have with respect to the game management system 100. For example, in some examples, the user can complete the game management tasks in less than 10 interactions (e.g., touch inputs). Further, the game management system 100 provides an interface in which the user can view game-specific and opponent-specific historical information, such as play selection and outcomes, in order to determine whether the play calling is in accordance with a game plan. Further, when combined with recorded outcome information, the interface provided by the game management system 100 enables the user to identify effectiveness of the play calling, as well as detect when the defensive adjustments of the other team start becoming effective.

With further reference to an example of FIG. 1A, the game management system 100 includes programmatic processes, represented by a data input interface 108, a user interface component 110, a game module 120, and an opponent module 130.

The data input interface 108 can ingest one or more data collections 105 from one or more sources or libraries, where the data collection 105 is for a specific opponent and game. The game management system 100 stores the data collection(s) 105 in a data store 102. The data store 102 can be stored on a user device. Alternatively, the data store 102 can be stored on the cloud, server or a remote computing device.

In examples, each data collection 105 includes multiple types of data objects, where each data object type is defined by a corresponding set of attributes that configure the data object. The data objects can include defensive type data objects, including data objects that represent, by type (or identifier) and/or other attribute, blitzes, coverages, defensive front play coverage and opponent personnel. The data objects can also include offensive play attributes, to identify offensive plays by identifier, situation, personnel, and other attributes. Still further, the data objects of the data collection can include player (or personnel) data objects, which identify player names and position. Further, the data objects can specify down and distance categories, field position categories, player names, and play identifiers (e.g., numerical). Additionally, the data objects can include a set of historical data objects.

In specific examples, the data collection 105 can include personnel a team may use for a game, including one or more positions for each player. Further, the data collection 105 can include information items for identifying play calls for when a user's team is on offense. These information items can include the personnel for the play, the play type, play concept, play formation, and other play configurations or attributes (e.g., adjustments, motion by type and position, blocking, etc.).

### Pre-Game Configuration

Prior to a game, the user can import a data collection to implement pre-configurations 111 on the user interface component 110. In particular, the data objects can pre-populate aspects of the user interface component 110, including selection features. For example, selection features, such as menu items, can be configured with personnel, play identifiers, terminology, and other aspects which are specific to the user's team. To illustrate, the data objects can specify personnel, such that the user can select individuals to reflect their involvement in a down, to enable the user to readily select personnel when selecting plays, recording results, etc. Likewise, the pre-configurations 111 can specify plays the user's team may run, categorizations which the team has identified for the opponent's defensive configurations, and various other aspects.

The pre-configurations 111 can configure the user interface component 110 to facilitate implementation of one or more workflows during a game. The workflows include each of (i) recording situational information (e.g., down, yardage, field position), (ii) play calling, (iii) recording defensive information, and/or (iv) recording outcome information. The workflows can be run for each down, to facilitate the user in implementing an effective game plan.

### Game-Time User Interactions

In examples, the user interface component 110 includes a set of features that collectively implement workflows for enabling the user to rapidly interact with the user interface device 90 to perform game management tasks. The user interface component 110 can include separate sets of interface features that enable the user to view information (e.g., situational information, analysis, etc.), to select plays for downs, and record information corresponding to situational information, defensive configuration information, and the outcome of the play that is run. The recorded information, represented by event data sets 115, can be stored in a game data store 125.

In the course of and after each down, the game management system 100 records information about events (“event data sets”) that occur during each down. The user can interact with features of the user interface component 110, which can be preconfigured based on data obtained from the data collection 105, to record the event data sets 115. In examples, the event data sets 115 can specify values (or attributes) for predefined data objects. For each down, the event data sets 115 specify (i) information about a defensive scheme or defensive plays/tactics that are run by an opponent (collectively referred to as “opponent information”), (ii) information about an offensive play call of the user's team (“offensive play call information”), (iii) situational information, and (iv) information about an outcome of the play call, including information that indicates the field position of the offensive team at completion of the down (“outcome information”).

The opponent information can, for example, specify attributes that identify a category, or set of categories, for a defensive arrangement used by the opposing defense on a given down during the game. For example, the attributes can specify the number and formation of the front defensive players, as well as the number of coverage players. The opponent information can also include actions that are recorded as being performed by the opponent's defense, such as blitzes (where defensive players charge for the quarterback of the offense of team). Thus, during a down of a game, the opponent information can be recorded at the beginning, during and/or upon completion of the down. In this way, the opponent information can reflect actions performed on defense by the user via the input interface component 110, as the down is played out.

In examples, the user interface component 110 includes one or more opponent panels 112 that include selection features to enable the user to select attributes that characterize the actions and activities of the opponent on defense. The selection features can be configured, based on attributes that are specified or indicated by pre-configurations 111, to enable the user to rapidly record opponent information. The opponent information characterizes, for example, the configuration or alignment used by the opponent, the actions performed (e.g., blitzes), and/or the personnel (by position and/or name) who performed the action.

The user interface component 110 can include a play call panel 114 to enable the user to record event data sets 115, reflecting offensive play call information, the opposing defensive formation, blitz and coverage, based on the situational information of down and distance, field position, and the outcomes of the called plays. The play call panel 114 can be configured, based on pre-configurations 111, to include selection features that are based, or otherwise configured to reflect attributes of data objects relating to offensive play calling. Accordingly, the pre-configurations 111 can be configured based on attributes of data objects that identify offensive plays, situations, and personnel. In this way, the user can interact with the play call panel 114 to record offensive play call information. The offensive play call information can be recorded to coincide with the user making a play call selection on a given down. In making the play call selection, the user can identify, for example, a category of the play (e.g., run or pass), a play concept (e.g., play name), a personnel set or combination to use (including positions or roles to use for the play call), offensive play concept (e.g., rush play or no huddle), alignment or positioning configurations and other configurations that reflects a characteristic (or category) of the play call. As described with some examples, a play call can be identified by play name having multiple component identifiers, where each component identifier identifies a configurable aspect of the play. Thus, the play name can identify multiple configurable aspects that reflect the user's selection.

The user interface component 110 can also include an outcome panel 116 to enable the user to record event data sets 115 corresponding to outcome information. The outcome panel 116 can include selectable features to enable the user to select or otherwise specify an outcome for a completed play (during a down). The possible outcomes can be selected from a predetermined set. In come variations, the outcome panel 116 can also be configured, based on pre-configurations, to configure the selection features to be specific to the user's team or the opponent.

The outcome information can reflect, for example, a distance or position of the ball after completion of the down, a type of play that is run (e.g., run versus pass), whether a pass was caught or incomplete, and/or whether a turn-over occurred (e.g., interception, fumble). The outcome information can also identify whether a penalty occurred during the down, and whether the penalty was against the offense or defense. As an addition or variation, the outcome information can identify whether, for example, the quarterback was sacked, whether the pass was blocked at the line of scrimmage, or other types of events which can provide valuable insight into game management. In this way, the outcome information can also reflect what transpires with respect to the defense. For example, if the opponent's defense blitzes, and the blitz is successful, the outcome information (as recorded by the user via the input interface component 110) can reflect that the blitz was successful (e.g., based on user input received through the input interface component 110, the defensive action resulted in the loss of yardage).

The user interface component 110 can include a situational panel 118 to enable the user to record event data sets 115 corresponding to situational information. The situational information can reflect, for example, down and yardage (to first down), and the position of the ball on the field. As an addition or variation, the situation information can identify a quarter or half when the down was played, and a time during the quarter or half when the down was played. In examples, some or all of the situational information is inferred by the game management system 100. For example, the game module 120 can update the down number and yardage based on the outcome information.

### Game-Time Analysis

In examples, a game event data store 115 can store event data sets 115 obtained through user interaction with input interface component 110. In examples, the game event data store 115 stores opponent information, offensive play call information, outcome information and situational information. Each of the game module 120 and the opponent module 130 access the game event store 115 to perform analysis of the event data, to generate situationally-specific analysis that can be rendered on one or more analysis panels 117, 119 of the user interface component 110.

In examples, the game event store 115 can be integrated or provided with the game data store. In some variations, the game event data store 115 can correspond to a structured set of data maintained in, for example, cache memory of the user interface device 90. The game event data store 115 structures event data sets, such that various types of event information is associated with corresponding situational information (e.g., down and yardage to first down). For example, the game event data store 115 can be structured as a tabular data set that lists each event data set by a play sequence number (representing all the downs played by the offensive team), such that the play sequence number is associated with corresponding situational information, offensive play call information, opponent information, and outcome information. As an illustrative example, the game event data store 115 can include row entries that identify a play number (e.g., play #15), a down number and yardage (e.g., “3^{rd} and 5”), a play call (e.g., offensive play identifier #103), and an outcome (e.g., incomplete pass). In further examples such as described below, the game event data store 115 can store additional information in association with each play/sequence run by the offensive team.

The game module 120 represents processes that access event information from the game event data store 115 to select pertinent event information relating to a current down. The game module 120 can generate an output data set 121 to, for example, display a result that identifies information relating to plays called by the user in prior downs. The results can display plays based on situation (e.g., down and yardage), outcome, type and various other parameters, based on information obtained from the game event data store 115.

In examples, the game module 120 implements processes to analyze and/or filter event information from the game event data store 115. The game module 120 filters, or otherwise selects event information for rendering on the user interface component 110 based on pre-determined parameters specified with analysis panels 117, 119 of the user interface component 110. In examples, the game module 120 selects information for a “self-scout” panel based at least in part on event information associated with situational information (e.g., downs) and other information (e.g., sequence number of plays). For analysis panels 117, 119 such as the “self-scout” panel, the gameday module 120 can select event information based on the series down (e.g., first down, second down, etc.) and/or the yardage to first down. Further, the situational information can be categorized, and the gameday module 120 can select event information by the category of the situational information (e.g., third down and short, third down and medium, third down and long, third and extra long, fourth and short, etc.). Based on situational information (e.g., down and yardage), the game module 120 selects data sets of event information from the game event data store 115. The game module 120 analyzes the selected data set to generate data sets for output on the analysis panels 117, 119. In this way, for example, a self-scout panel 117 can display entries that reference play call information of the user's team, during a current game, with situational information and/or outcome information. For example, in referencing play call information against situational information, the gameday module 120 can identify (i) a number of plays of each category that was previously run in a same or similar situations during the game (e.g., run versus pass play on same down), (ii) a number of plays of each category that were previously run in same or similar situational categories during the game, (iii) categorical information about prior play calls in same or similar situational categories during the game, where the categorical information can include, for example, run play versus pass play, personnel set or combination categorization, and/or offensive concept categorization. As an addition or variation, the play call information can also be referenced against outcome information, such as information that indicates a yardage gain, and whether the outcome achieved a first down. In some variations, the play call information, situational information, or outcome information can be referenced by statistical data, such as the percentage of time when a particular type of play call resulted in yardage that exceeds a threshold amount (e.g., five yards). In this way, the game module 120 can generate situational-specific offensive information for rendering through analysis panels 117, 119.

The opponent module 130 represents processes that access event information from the game event data store 115 to select pertinent event about the opponent, and specifically, opponent information that is highly relevant to a current situation and/or play call. The opponent module 130 can generate an opponent output data set 123 for analysis panels 117, 119 to, for example, display a result that identifies information relating to the opponents, such as the configuration, personnel, and outcome of the opponents selected defense. Further, the opponent module 130 can reference play call information, outcome information and situation information against opponent information, based on information obtained from the game event data store 115.

According to examples, the opponent module 130 filters or selects event information from game event data store 115 based on the current situation information, in order to generate data sets that reference opponent information with relevant situational information. The opponent information can reference defensive schemes (e.g., defensive play, formation of front players, formation of coverage players, etc.), and actions that are recorded as being performed by the opponent's defense (e.g., blitzes), during the game. This type of event information can be referenced against, for example, situational information that occurred in prior downs, as well as outcome information, indicating whether, for example, a defensive scheme was successful or not in the game.

As an addition or alternative, the opponent module 130 can filter or otherwise select historical opponent data retrieved from, for example, the data store 102. The retrieved information can be referenced against relevant situational information. The retrieved historical opponent information can reference defensive schemes (e.g., defensive play, formation of front players, formation of coverage players, etc.), and actions that are recorded as being performed by the opponent's defense (e.g., blitzes), during prior games of the opponent. In this way, the opponent module 130 can generate situation-specific historical opponent information for rendering through one or more analysis panels 117, 119.

Accordingly, as described with examples, the game management system 100 provides a user interface component 110 that enables the user to effectively and rapidly perform game management tasks. The user interface component 110 is configured to minimize user-interaction, while enabling the user to specify requisite information relating to the opponent, the play call and the current situation. In some examples, the user interface component 110 enables the user to specify the requisite information with ten or less “touches” to the touch-sensitive display of the-user interface component 110. This allows the user to perform the game management tasks in sufficient time, to allow for the user to consider important information on play calls.

Additionally, the user interface component 110 can display information determined through analysis of event data sets, where the information is highly relevant to play selection based on various attributes, such as prior play calls, outcomes, and opponent configuration/plays. In this way, the user interface component 110 enables the user to view highly relevant information for making play calls, in a situation-specific and time-sensitive game environment.

Upon completion of a game, the game data store 125 can be exported via the export interface 106. The exported data set can be exported as a report. As an addition or variation, the output of the export interface 106 can be merged or combined with video files to facilitate review of the game after it is played.

### Dynamic Responsive Interface Features

Aspects of the user interface component 110 can be dynamic and responsive to events. The analysis panels 117, 119 can reflect statistical and aggregate analysis information that can be based at least in part on play-calls and outcomes that occur during a game. In examples, once information about a play-call is recorded with the game data store 125, the output information of the analysis panels 117, 119 can automatically change to reflect the newly added information. Additionally, the context information (e.g., down, yardage) can change after a play, and the analysis panels 117, 119 can dynamically change to reflect analytical/predictive information (e.g., recommended play-calls, aggregate results from prior events in game, etc.) that is specific to the context information.

In some examples, the game management system 100 includes prediction logic that utilizes data sets of the data store 102 and/or the game data store 125 to make predictive inferences that facilitate the user in providing input and performing game management tasks. The prediction logic can generate, for example, inferences that predict the defense configuration (e.g., alignment, personnel) the opponent will use. The predictive inferences can be displayed as part of, for example, the analysis panels 117, 119.

As an addition or variation, the prediction logic can use event data sets 115 of the game data store 125 to generate one or more recommendations for play calls which the user can make, or attributes of play calls.

Still further, the prediction logic can use the event data sets 115 to predict information the user will enter via the user interface component 110, to further reduce the amount of interaction which the user is required to make in performing a game management task. For example, the prediction logic can pre-populate one or more panels and input features of the user interface component 110.

By way of example, prediction logic can analyze recorded information of game data store 125 to select a play-call for the user. The selection of the play-call can be based on factors include (i) a predetermined game strategy, (ii) yardage/success rate of prior plays, (iii) the defensive scheme that is anticipated to be run by the opponent, based on, for example, similar context (e.g., down and yardage) in the current game or prior game, and (iv) the frequency of prior called plays (e.g., to avoid play-calls that are overused so as to become predictable.

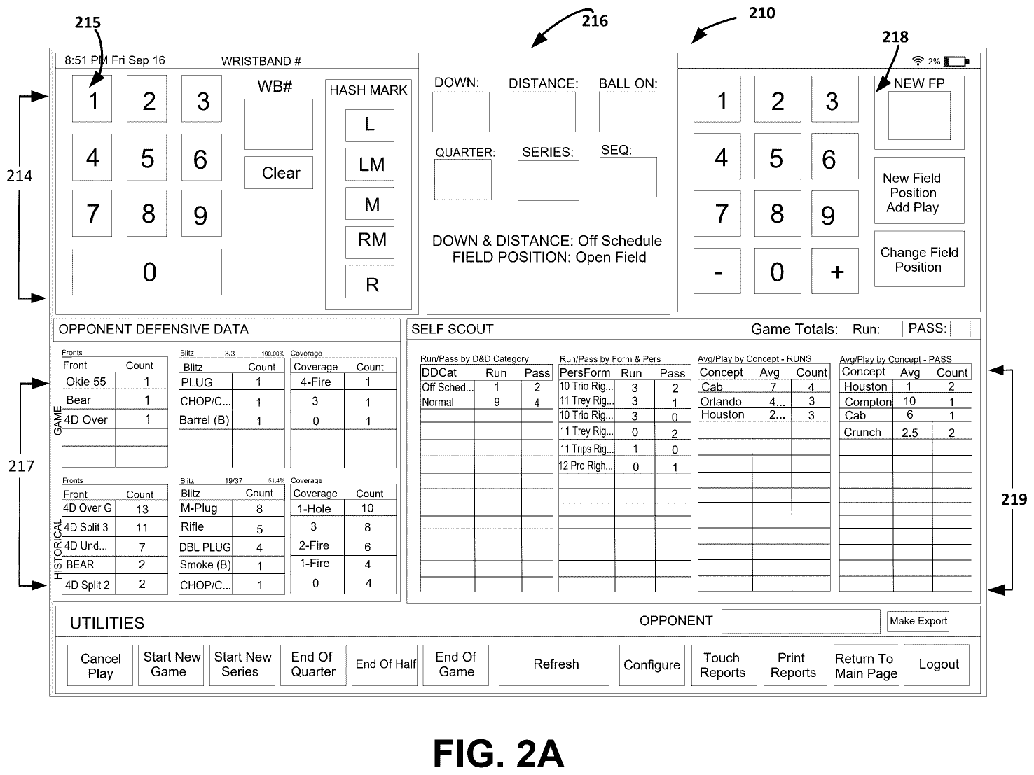

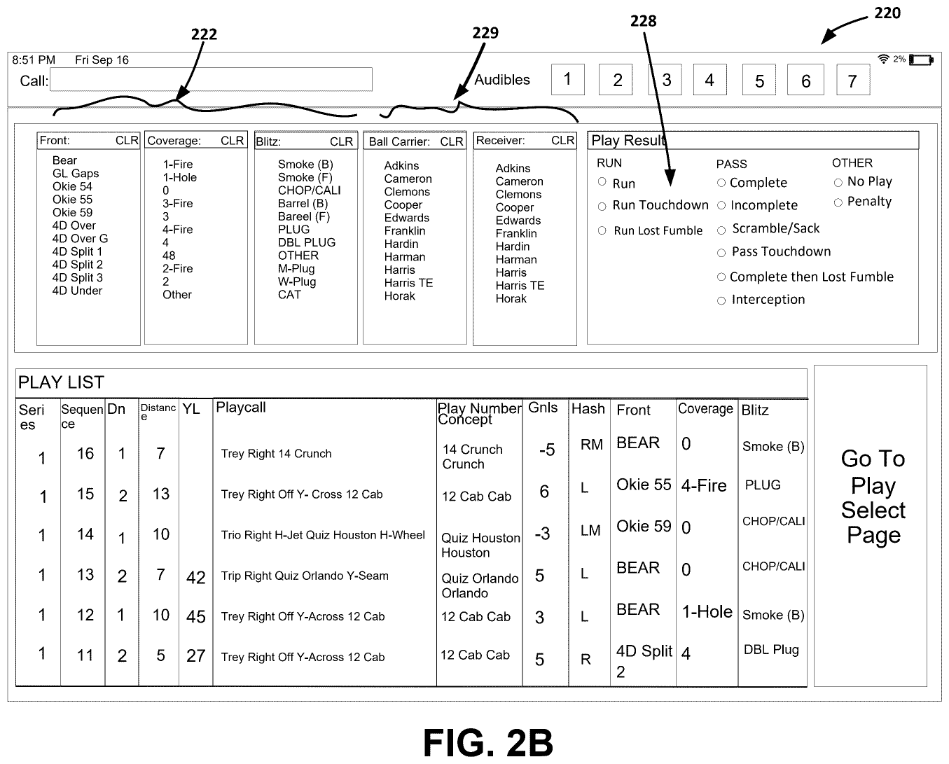

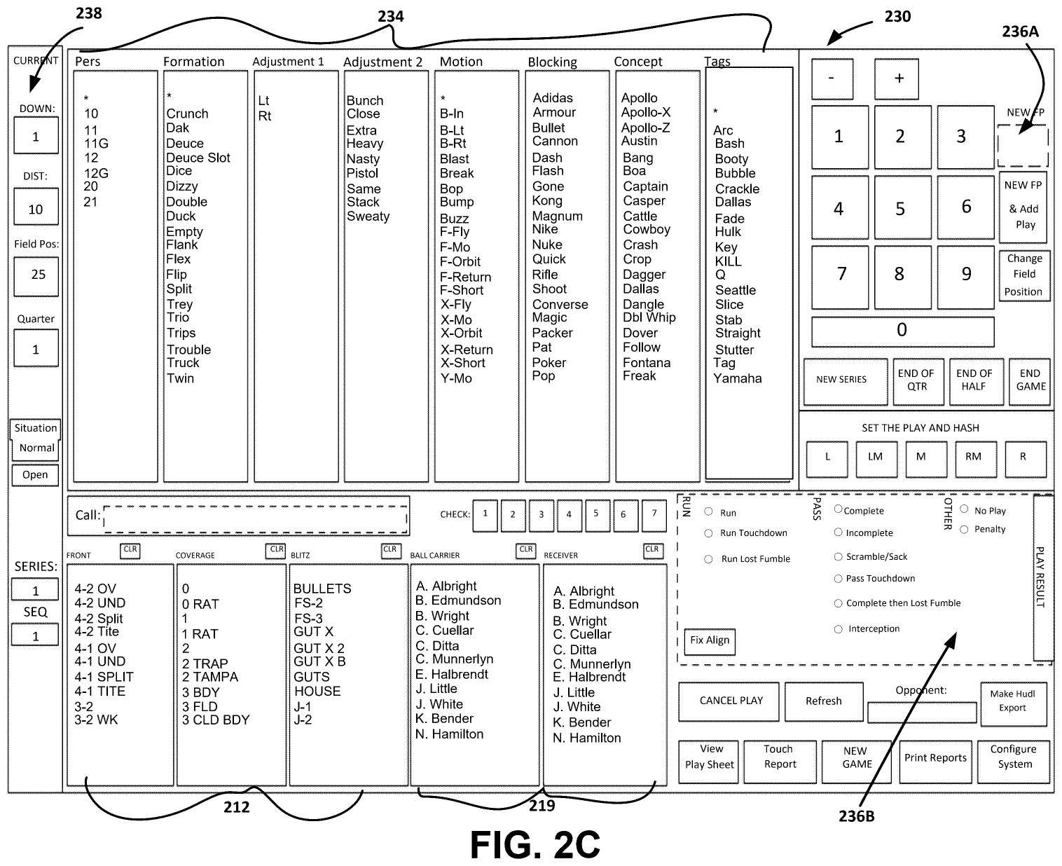

In examples, the prediction logic can make store one or more recommended plays calls in with the game data store 125. The recommended play-calls can be for the next play, next set of plays, and/or for specific context/situations. The user interface component 110 can retrieve predicted play-calls and pre-populate or pre-select features of the play-call panel 114 and/or event panels 115. With reference to FIG. 2A, the play-calling panel 214 can be pre-populated with an identifier of a play-call. The user may specify, for example, the hash and reduce the number of interactions/touches required to call the play. With reference to FIG. 2C, the series of play-calling panels 214B can preselect menu items to reflect the recommended play-call for the user.

In examples, the prediction logic can also generate a set of predictions regarding the opponent defense. The predicted information can identify, for example, one or more defensive schemes, formations, blitzes, personnel or other information (“defensive plays”). The predicted defensive information can be displayed in, for example, the opponent analytic panel 117. The prediction logic can include processes that scan the historical information about the opponent to determine a probability for one or more defensive plays which the team may face on a given situation. For example, the prediction logic can generate the most likely defensive play the user's team will face with the next or subsequent play call. Alternatively, the prediction logic can generate the top 2 or 3 most likely defensive plays that the user's team will face with the next or subsequent play call. The predictions for defensive plays can be based at least in part on situational information, as well as tendencies of the opponent, recent plays, overall score, weather, time of day (e.g., whether game is played at night or during day), the location where the game is played (e.g., home or away) and various other factors.

In some examples, the predictions for defensive plays may be based initially on historical information. As the game progresses and defensive plays are recorded by the user with the game data store 125, the prediction logic may incorporate in-game information to determine the predictions. Depending on implementation, the in-game information can be weighted more or less and historical information from the opponent's other games. Further, the weights assigned to various factors for making the prediction can also be based on part on factors such as overall score, weather, time of day (e.g., whether game is played at night or during day), the location where the game is played (e.g., home or away).

### Multi-User Network and Synch

In some examples, multiple personnel from a given team can record game data information through interaction with a corresponding user interface device. For example, a first personnel can record an opponent's play call or defensive scheme, a second personnel can record the team's offensive play call, and a third personal can record situational information and outcome. Yet further, another personnel can view the data and select play calls. In examples, the game management system 100 can include a synchronization component 140 that synchronizes the input sets from each user interface device 90. The user interface devices 90 can be linked to communicate continuously (e.g., using a wireless network, such as cellular or Wi-Fi) with one another, such that each device includes a copy of the game data store 125 that includes information recorded by each of the personnel. In this way, the game management tasks can be distributed to multiple users, and each user can have a consistent view of the game data store 125.

### Recommendation Engine

FIG. 1B illustrates an example of a recommendation engine 150 for the game management system 100, according to one or more embodiments. The recommendation engine 150 can execute on the user device to generate one or more sets of recommendations for user selection during a game. In examples, the recommendations include a recommended set of off play calls for a next down, or for one or multiple upcoming downs (e.g., for next 3 downs). The user can then interact with the user interface device 90 to select to perform the task of play selection.

The recommendation engine 150 can be implemented as either a module or an integrated component of the game management system 100. In alternative implementations, the recommendation engine 150 can be distributed between a user device and a network system or service. For example, the recommendation engine 150 can implement as a network or remote component that communicates with the user interface device 90 to receive in-game information and to output recommendation data sets 155, as described herein.

In examples, the recommendation engine 150 includes a model and prediction logic data store 156 and an execution component 160. The model/logic store 156 can store model data sets 155 for implementing stochastic and/or machine-learned models for generating recommendation data sets 155. During the game, the execution component 160 can retrieve and implement one or multiple models using the model data sets 195 stored in the model/logic store 156. The model data sets 195 can include stochastic values and weights that are machine learned based on historical information 105B.

The individual models can include play call or defensive scheme selection models that recommend play calls or schemes from a library of play calls or schemes, based on a particular objective. For a play call, models can be developed to promote an objective of identifying efficient play calls, where efficiency is predefined. For example, an efficient play call can be defined as one that (i) if called on first down, gains 4 or more yards; (ii) if called on another down, achieves a first down greater than 10 yards, or half of the distance to the first down marker; and (iii) for third or fourth downs, converts to a first down or to a touchdown,

In variations, additional models can be developed for alternative objectives, such as maximizing yardage per play, or efficiency in respect to advancing the ball a short number of yards in short yardage situations (e.g., “4^{th} and 1, goal line, etc.). Thus, models can be developed for specific situations, such as short yardage situations. As described with examples, the models can be adaptive to events that occur during the game. For example, if a play call has an efficient outcome, the weights associated with the model that generated the particular recommendation can be adjusted positively, to make subsequent recommendation of the play call more likely, particularly in similar situational information.

### Model Development

In examples, the execution component 160 uses models developed by model development component 190. The developed models can include stochastic machine-learned models, such as Hidden Markov Models, Gaussian Mixture Models, Bayesian Networks, stochastic regression models, and graph nodes. Multiple models can be developed and deployed for a game, including separate models for achieving different objectives. For example, a first set of models may be used for when the game is close, where the models are trained or otherwise developed to identify play calls that maximize yardage and/or are most likely to generate an efficient outcome. A second set of models can be used when specific conditions occur such that the desired objective for the play call changes. For example, when a team falls behind at end of game, the objective may change from efficiency to identifying play calls that are likely to gain the most yardage, or more than 20 yards. Likewise, specialized models may be used for specific situations, such as low-yardage situations (e.g., fourth and 1, goal line, etc.).

The model development component 190 can be implemented pre-game to develop models utilizing the data collection store 105 and a historical data store 105B. The data collection store 105 can identify, for example, the team personnel, the play type, concept, formation, and other configurations or permutations (e.g., adjustments, motion by type and position, blocking, etc.). The model development component 190 can also use historical information 105B, reflecting the teams play calls from prior games. The historical information 105B can identify play calls by personnel deployed, play calls by, for example, type, concept, formation and other configurations and permutations. Further, the identified plays can be cross-referenced to outcomes, reflecting, for example, yardage gained (or loss), past completion or incompletion, whether the execution of the play call resulted in the score (e.g., touchdown), whether the execution of the play resulted in a turnover (e.g., fumble or interception), and/or whether execution of the play call resulted in some other outcome (e.g., penalty, no play, scramble run or broken play, etc.). In examples, the play calls and scheme selections identified from historical information can be referenced to outcomes that include a value reflecting whether the play call or scheme selection resulted in an efficient outcome. Further, the historical information 105B can reference play calls with outcomes and situational information, such as down and yardage. Other types of information which can be referenced with the play calls can include, for example, the weather, the score, an expected score for the game or portion thereof (e.g., point spread), player evaluations, and/or game objectives of the coach (e.g., slow-paced, ball control, pass-heavy, etc.).

In some examples, the historical information 105B can also include information about a team's defensive schemes, such as personnel, formations (e.g., front formation, coverage formation), and blitz configurations. The defensive schemes which the team has used in prior games can be cross-referenced to outcomes of those plays, as well as situational information (e.g., down and yardage, field position) when the individual defensive schemes were employed.

In examples, the historical information 105B can also include similar data sets for an opponent of a team, both with respect to offense of play calls and personnel and defensive schemes and personnel.

In examples, the model development component 190 can utilize the data collection store 105 and the historical data store 105B to develop model parameters that reflect weights, probabilistic values and prioritizations. As an addition or variation, can train models based on the historical data store 105B, for purpose of making determinations utilized in determining recommendation data sets 165.

In examples, the model development component 190 develops a set of models or logic for deployment during a game, including an offensive and/or defensive selection model. The offense play selection model can utilize a team's library of play calls, where the play calls can be specified with alternative configurations, personnel or permutations. Likewise, the defensive scheme selection model can utilize a library of defensive schemes, where the schemes can be specified with alternative configurations, personnel or permutations. Further, the model development component 190 can develop multiple models for different scenarios. For example, the model development component 190 can develop separate models for situations where the user's team is ahead or behind at a given point of a game. As another example, separate models can be developed for situations where the user's team is in regular mode or no-huddle mode.

Further, the model development component 190 can develop models with weights, priorities, rules and/or other logic (collectively “model parameters 195”), where the model parameters correlate to preferences, conditions, and/or criteria with individual play calls and defensive schemes. For example, the model parameters can reflect weights or rules for or against specific offensive play calls and/or defensive play calls based on corresponding game conditions. For example, the model parameters 195 can determine weights or specific rules that are specific to specific downs, yardage to first down, down and yardage condition, time interval during game, game score condition (e.g., which team is ahead) and/or special situations. Preferences for specific play calls or defensive schemes can be specified by input (e.g., coach ranking, direct input), and/or through analysis of data collection 102 and/or learned from historical data set 105B (where data mining processes determine preferred play calls or defensive schemes by, for example, count, count against specific situations, or other statistical analysis). In some examples, the preferences can be determined from plays which are scripted for a given time interval in the game. A coach may, for example, designate the play calls for the first 10 plays of a game, or for a first series starting a second half. The scripted plays can be imported as part of the data collection 105.

In examples, multiple sets of models and/or model parameters 195 are developed. For example, the model development component 190 can develop separate models for recommending a set of play calls on offense, recommending a set of defensive schemes on defense, predicting an offense play call by an opponent, predicting a defensive scheme by an opponent, and/or predicting an outcome of a play call or defensive scheme.

In examples, the model development component 190 can, for example, access historical data 105B to aggregate play calls and defensive schemes from prior games, including identifying situational information and corresponding outcomes for the opponent's play calls and/or defensive schemes. The model development component 190 develops statistically derived weights for a model parameter set 195 that is predictive of the play call or defensive scheme selection of the opponent and/or an outcome of the play call or defensive scheme selection. In this way, each play call or defensive scheme of the opponent can be associated with one or multiple scores, reflecting a probability of the play call or defensive scheme being selected by the opponent and/or a strength of the selection (e.g., a likelihood of a particular outcome, or an aggregate of multiple possible outcomes).

In some examples, the model development component 190 can also develop a simulation model that simulates an outcome for a play, given a predicted play call on offense and a predicted defensive scheme on defense. The simulation model can, for example, be executed at game time to generate a score that reflects one or more of a most likely outcome, or a probability of multiple outcomes (e.g., 50% of efficient outcome, 20% chance of inefficient outcome, 30% chance of explosive outcome, etc.).

In some examples, the models that are developed for execution during game time include adaptive models that tune or update during game time. Still further, the models can be generative to devise new plays, rather than select plays from a library. The play creation can be based on inputs such as predicted opponent defensive schemes or plays, as well as, for example, events or conditions that warrant large adaptions to the models.

### Model Execution Component

During a game, the execution component 160 can load a set of models that are configured for the particular game. For example, the execution component 160 can download the models before the game and store the models in cache or application memory for execution during the game. The execution component 160 can execute in response to game events, which may correlate to user inputs provided through the user interface 110. In response to the user input, the execution component 160 executes play/scheme selection logic 162 to generate a recommendation data set 165 that identifies a set of recommended initial play calls. The execution component 160 can also execute opponent play/scheme prediction logic 162 to predict one or more likely defensive schemes from the opponent. Still further, the execution component 160 can execute outcome prediction logic 166 to determine a score or other output that is predictive of an outcome for each play call of the recommended set. In this way, the recommendation data set 165 identifies one or multiple play calls, along with one or more possible defensive schemes from the opponent, and one or more values that can indicate a probability or likelihood of an outcome for each play call of the recommended set.

### In-Game Execution

In examples, the recommendation engine 150 includes a game data store interface 152 and an in-game model tuning or updating component 154. The game data store interface 152 can include processes that continuously or repeatedly read from the game data store 125 to identify updates to the game data store 125, and further communicate gamed data updates to the model tuning/update component 154. The game data updates can include situational information (e.g., down, yardage, field position, time, etc.), identification of opponent's defensive scheme (when user is on offense) or opponent's play calls (when user is on defense), and outcomes of the play calls. In examples, the game data store interface 152 automatically detects the update to the game data store 125 (corresponding to the offensive defensive scheme identified by the user), and communicates corresponding game data update 157 to the model tuning/update component 154.

The model tuning/update component 154 can include processes to analyze the game data update 157 and generate a model update 159 to the model parameter set 165 of one or more models in use by the execution component 160. The model update 159 can identify one or more of (i) the selected play call or defensive scheme by the user's team, (ii) the actual play call or defensive scheme used by the opponent, and (iii) the actual outcome of the play. The model tuning/update component 154 can execute processes that are configured for specific models deployed with the execution component 160 to determine the model updates 159 in accordance with, for example, a format or configuration of the model in use.

In examples, the execution component 160 can be responsive to game update data (e.g., user enters information in advance of a play). For example, based on situational information, the execution component can run to recommend a candidate set of plays (e.g., based on a likelihood of achieving an efficient outcome), as well as to predict an offensive play call or defensive scheme of the opponent. The execution component 160 can receive the model updates 169 and implement updates to the executed models. In this way, the execution component 160 can tune individual models in use for one or more of play call or scheme selection, predicting opponent's play call or defensive scheme selection, and predicting outcomes of selected play calls and defensive schemes.

As described in detail, model updates 159 can be determined repeatedly in response to game events, such as play call and defensive scheme selections, opponent selections, and actual outcomes. The execution component 160 can implement the model updates 159 in real-time (or near real-time), such that the recommended data sets 165 are dynamically updated on the recommendation panel 180.

### Example Implementation

By way of illustration, initially, the recommendation engine 150 can generate a recommended data set 165 for the recommendation panel 180. In examples, the recommendation panel 180 can be implemented as or included with an information region 262, 264, or 266. In some examples, the recommended data set 165 can identify (i) a set of candidate plays or defensive schemes for the user to select from; (ii) a set of predicted play calls or defensive schemes for the opponent; and/or (iii) one or more scores reflecting a predicted outcome for a selected play call. In examples, the recommendation panel 180 can be persistently displayed to include content that reflects the recommended data set 165. Further, the recommendation panel 180 can dynamically update to reflect updates to the recommended data sets 165.

Prior to the first offensive play, the user input can initially provide situational information (e.g., down, yardage, field position, time following an initial kick-off). The game data store interface 152 identifies a game data update 157 that reflects the initial situational information. The execution component 160 can update the set of model parameters 195 used by play/scheme selection logic 162, where the candidate set may or may not change. Further, the execution component 160 can execute play/scheme selection logic 162 to generate or update the set candidate set of play calls. Additionally, the execution component 160 may update a score associated with an outcome for one or more play calls of the candidate set.

Subsequently, the game data store interface 152 can detect an entry from the user identifying the defensive scheme of the opponent. The corresponding game data update 157 identifies the defensive scheme. The model tuning/update component 154 compares the identified defensive scheme to the prediction(s) generated by opponent play/scheme prediction logic 162 for that play. The model tuning/update component 154 can generate the model update 159 to update, for example, weights or probabilistic values of the model parameters 195 for the model(s) used by opponent play/scheme prediction logic 162, based on the correctness of the prediction. For example, if the predicted defensive scheme was correct, then the model update 159 may generate the model update 159 to reinforce the model deployed with opponent play/scheme prediction logic 162. On the other hand, if the prediction is wrong, the model update 159 can provide tuning for the model.

The game data store interface 152 may next identify the play call selection of the user, based on user input that identifies the offensive play call by type, concept, configurations and other permutations. In some cases, the play call may be known or predicted by play/scheme selection logic 162, based on, for example, a predetermined set of plays the user indicates will be run. For example, an initial play call for a game may be predetermined by a coach and reflected in a game plan which is imported. In other cases, the recommendation engine 150 generates recommendations for play calls to accommodate a preference of a coach or team. Still further, in order cases, the recommendation engine 150 can generate a candidate set of play calls, each of which is associated with a score reflecting a predicted outcome if that play call is selected. Upon completion of the play in the game, the game data store interface 152 can generate the game data update 157 to identify the situational information (e.g., down and yardage) and the outcome after completion of the play call (as provided by user input through the user interface 110). The model tuning/update component 154 can normalize the outcome to reflect, for example, the model tuning/update component 154 can determine a classification or label for the play call's outcome, reflecting the outcome as being not efficient, efficient or explosive. In variations, the outcome can be expressed by yardage or other metric. The model tuning/update component 154 can compare the actual outcome of the play call with the predicted outcome, and generate a set of model parameters to update, for example, the model data 195 used with play/scheme selection logic 162 and/or 166.

The sequence of operations described above with respect to an initial play set can be repeated for subsequent series of plays on the part of the user's team. As the game progresses, the efficiency of select play calls during the game can be determined and displayed alongside other metrics (e.g. a predictive score reflecting an outcome of a play call).

On defense, examples provide for the game data store interface 152 to detect the offensive play call of the opponent. The offense of play call can identify, for example, a formation, configuration and permutations which are detected by the user. The model tuning/update component 154 can process the update game data to compare the predicted play call for the opponent (e.g., as determined by opponent play/scheme prediction logic 162) with the actual play call of the opponent. The model tuning/update component 154 can generate the model update 159 to update the model data set 195 for opponent play/scheme prediction logic 162. Once the play is executed on the field, the game data store interface 152 can determine the situational information that outcome, generate the game data update 157 to reflect information about the opponents play call and outcome of the plays execution. The model tuning/update component 154 can generate the model update 159 to update the model data set 195 used by the predictive models of opponent play/scheme prediction logic 164 and/or the outcome prediction logic 166.

### Example Interfaces

FIG. 2A and FIG. 2B illustrates a first example of a user interface for rendering on a user interface, according to one or more embodiments. FIG. 2C illustrates a second example of user interface for rendering on a user interface, according to one or more examples. Example user interfaces 210, 220, 230 such as shown/described with FIG. 2A-2B and FIG. 2C can be generated by a game management system 100, such as described with FIG. 1A. The user interface component 110 (FIG. 1) can generate the example user interfaces 210, 220, 230. Accordingly, in describing examples of FIG. 2A through FIG. 2C, reference is made to elements of FIG. 1A for purpose of referencing functionality provided through a feature of the example being described.

In FIG. 2A, the user interface 210 can be generated as a primary interactive screen for use by a user device (e.g., tablet). The user interface 210 can be structured to provide multiple panels, including a play calling panel 214, situational panel 216, outcome field position panel 218, an opponent defensive analytic panel 217, and a self-scout panel 219. With reference to FIG. 1A and FIG. 2A, the play calling panel 214 illustrates an example implementation of the play call panel 114; the situational panel 216 illustrates an example implementation of situational panel 116; the outcome panel 218 provides an example implementation of the opponent panel 118; the opponent defensive analytic panel 217 illustrates an example implementation of the analysis panel 117; and the self-scout panel 219 illustrates an example implementation of the analysis panel 119.

As shown with an example of FIG. 2A, the play calling panel 214 includes a number pad 215 to enable the user to specify a series of numbers (or characters) (e.g., 2 or 3 digit number) that combine to identify a particular play call. The play calling panel 214 can also include one or more selection features (e.g., corresponding to lateral position of ball on field after prior down) to enable the user to specify alternative configurations of the play call.

The situational panel 216 displays situational information for the game. The situational information can include down, distance (to first down), ball position, play call sequence number, timing information (e.g., quarter, play clock value, etc.). In examples, the situational panel 216 can display parameters, corresponding to “Down & Distance” and “Field Position”, based on user-specific terminology and definitions. The situational panel 216 can also include configurable elements to receive and/or display specific types of information, such as fields that classify the down and yardage or field position. Thus, the value associated with the parameters, shown to be “Off Schedule” and “Open Field” can include user-specific terminology and definitions. The definition of each parameter value can reflect values, or ranges thereof, for the situational information displayed through the situational panel 216. For example, the user can specify a configuration where the value for “Down & Distance” corresponds to “Let it fly”, where “Let it Fly” is defined as 3^{rd} down and 7 or more yards to go.

In some examples, the information provided through the situational panel 216 can be determined programmatically, based at least in part on the outcome information provided by the user. The situational panel 216 can include a quick input field to enable the user to enter yardage information. Once the context/situational information is entered, the parametric values for “Down & Distance” and “Field Position” is displayed, corresponding to configured name/values that are predefined by the user.

In examples, play calling panel 214 shown with FIG. 2A is configured in accordance with a first style or form of play calling, where plays have numeric identifiers (e.g., “103”). Before the user enters the play calling information, the situational panel 216 provides the user with information regarding a current situation of the game, where the situational information includes the down, yardage to first down, field position, quarter, series number, and play sequence identifier. Once the down is complete, the user can interact with the number pad of the outcome panel 218 to enter field position upon completion of the play. Additional outcome information can be provided through one or more additional panels or regions of the user interface 210.

The opponent defensive analytic panel 217 can include opponent information, by type/category, and in aggregate. In some examples, the information displayed with the opponent defensive analytic panel 217 can be based at least in part on recorded information, such as may be provided by a user through the user interface 210 and other interfaces (e.g., user interface 220 of FIG. 2B). In some variations, the information displayed with the opponent defensive analytic panel 217 can also utilize historical opponent information of the opponent from other games (e.g., such as may be obtained from the data store 102). In this way, the opponent defensive analytic panel 217 can provide situational-specific information about the opponent to optimize play calling.

In an example of FIG. 2A, the information displayed with the opponent defensive analytic panel 217 includes opponent information from the current game (in-game information) or previously played game, which can be retrieved from the game event data store 125. The opponent defensive analytic panel 217 includes processed (e.g., aggregated) information, based at least in part on information that the user was able to record in prior downs, such as related to opponent configurations (e.g., reference defensive schemes, defensive play, formation of front players, formation of coverage players, etc.), as well as actions that are recorded as being performed by the opponent's defense (e.g., blitzes). This opponent defensive analytic panel 217 can reference the opposition information against, for example, situational information that occurred in prior downs of the current game, as well as outcome information, indicating whether, for example, a defensive scheme was successful or not in the game. In this way, the opponent module 130 can provide the opponent defensive analytic panel 217 to include situation-specific gameday opponent information, to facilitate the game management task of play calling.

The self-scout panel 219 can provide output data set 121. For example, the self-scout panel 219 includes play calling information specific to a current situation (e.g., down and yardage), the respective outcomes (which can be provided in aggregate), and historical information related to the game to display information about play calls (e.g., count of plays by each type) and their respective results.

The self-scout panel 219 can provide output data sets 121 generated by the game module 120 (see FIG. 1), based on the event data sets 115 recorded with the game data store 120. In this way, the self-scout panel 219 displays aggregated, or otherwise processed information about called plays, and more specifically, information about called plays that are specific to a current game situation. In examples, the self-scout panel 219 includes information that identifies (i) plays which the user ran in a same down in the game, (ii) plays which the user ran in a same or similar distance (to first down) situation, and/or (iii) plays which the user ran om a same or similar down and distance. Further, the self-scout panel 219 can provide multiple different aggregations of offensive play call information, such as a categorical designations of plays by run/pass, representing a total number of plays that have been called during the game of specific categories (e.g., pass versus run). The aggregate information can also be filtered or made specific to the situational information. The self-scout panel 219 can include sub-segments to display multiple variations of data sets determined by the game module 120. For example, the sub-segments can display categorical information about prior play calls in the same or similar situational categories during the game, where the categorical information includes run play versus pass play, personnel set or combination categorization, and/or offensive concept categorization.

Further, the self-scout panel 219 can provide information which separately tracks the total number of run and pass plays ran by an offense. In examples, the self-scout panel 219 includes sub-elements that are structured as tables. Based on recorded events stored with the game event data store 115 (see FIG. 1), the self-scout panel 219 includes tabular offensive play call information, specific to a current situation. The information tracks specific game situations. By way of example, the self-scout panel 219 can aggregates different sets of offensive play calling information by relevant situations to a current situation. The self-scout panel 119 can also indicate outcome information for identified plays, such as whether or not a run or pass play was ran, whether or not a pass was completed (if attempted), what yardage was obtained, etc. In this way, the self-scout panel 219 tracks how often a specific offensive play and/or play type was ran based on the recorded down and distance situations that have been recorded for each event throughout the current game.

In some examples, the opponent defensive analytic panel 217 and the self-scout panel 219 can include information that is generated based on information provided by the simulation panel 216. For example, each of the opponent defense panel 217 and the self-scout panel 219 can display information that is generated by a corresponding process that queries the game data store 125 for in-game play calls that are executed or otherwise associated with a given set of situational information, where the given set of situational information is determined from the situational component 216. For example, the given set of situational information can be determined from the down, yardage, “Down and Distance” parametric value and/or “Field Position” value. In examples, the user can manually override or otherwise change the situational information by, for example, interacting with the situational panel 216 to change the down, distance, yardage and/or other parametric values (“Down and Distance” parametric value and/or “Field Position” value). The values of the situational panel 216 can be changed without a play call being recorded with the game data store 125. But the change to the situational panel 216 can automatically trigger the process(es) of the opponent defensive analytic panel 217 and self-scout panel to retrieve additional or alternative information from the game data store 125, where the retrieved information is specific to the information displayed by the situational panel 216. Alternatively, any change to the game data store 125 can automatically trigger a process by which the user interface 110 scans the idea and updates a corresponding field of the user interface 110. In this way, the situational panel 216 can be interactive to enable the user to simulate a condition (e.g., by manipulating or overriding down/yardage and field position), in order to view what information is rendered in one of the opponent defense panel 217 and/or self-scout panel 219.

For example, if the actual game situation is first down and 10 for the user's team, the user can weigh the risks of calling a pass play for extra yardage by simulating a situation where the pass-play results in a dropped pass (so no yardage is gained). The user can manipulate the situation panel 216 to change the down/yardage to second and 10, to see what information is displayed about the opponent (e.g., the tendency of the opponent and their success for second and 10 situations) in the opponent defense panel 217 and/or what information is displayed for the self-scout panel 219 (e.g., plays and outcomes the user's team has had in second and ten situations). The user can then cause the situation panel to revert to its prior state (e.g., to match the outcome panel 218), where the play call can be selected for first and 10.

In FIG. 2B, the user interface 220 can also be generated by the user interface component 110. The user interface component 220 can be provided with, for example, the user interface 210. For example, once the user enters the play call using the play call panel 214 (FIG. 2A), the system 100 can automatically transition from the user interface 210 to user interface 220. The user interface 220 includes an opponent panel 222 and/or an outcome panel 228.

With reference to FIG. 1A and FIG. 2B, the opponent panel 222 illustrates an example implementation of opponent panel 112; and the outcome panel 228 illustrates another implementation of the output panel 118. As described, the user can interact with the output panel 228 to record information about how the outcome of a play call that was just implemented by the team. In some variations, the user makes a selection of the options in the outcome panel 228, and the system 100 transitions back to the user interface 210, where the user enters field position. Based on the value of the field position, the yardage of the play call is determined. Information about the play call can be recorded to reflect outcomes corresponding to one of the options of the outcome panel 228, as well as the yardage in the outcome panel 218 of the user interface 210. Combined with the yardage input field, the outcome panel 228 can enable the game data store 125 to record by type of output, where the yardage gain or loss is calculated based on the change in the field position between downs.

In examples, the opponent panel 222 can be structured to include selection menus or other features, to enable the user to select attributes reflecting characteristics of a defensive alignment or scheme which the opponent uses in a current down (e.g., defensive coverage, formations, blitz and permutations). In some variations, the number of selection menus can be determined based at least in part on pre-configurations 111. For example, one opponent may have a greater number of options for defense as compared to others, in which case the user interface component 110 generates a greater number of selection menus for the opponent panel 222 of the user interface component 110.

In implementation, the user interfaces 210, 220 implement a work flow for the user to manage a game. At the start of a series of downs, the user can interact with the field position feature of the outcome panel 218 to enter the field position of the user's team (1-2 taps). Further, the user can specify a play using the number pad of the play calling panel 214 (1-3 taps). In this way, the user can complete the play calling task of game management in 2-5 taps. The user can be moved to the second screen 220 to interact with the opponent panel 222, where the user can enter information about the defensive formation, blitz and coverage. Based on the user's observation, the user can record information that accurately reflects aspects or characteristics of the opponent's defensive configuration (3 taps). Further, as the play is executed, the user can record information about the play call, such as the personnel used during the play, using play personnel selection features 219 (e.g., menu features). As described with some examples, the selection features of the opponent panel 222, as well as play calling personnel features 219, can be configured using the pre-configurations 111. After the initial down, the user can interact with the panels and features of the user interface 210 and 220 to (i) select the play call, and (ii) record opponent information, play call information and outcome of the called play. Further, when making the play call, the user can view situation-specific opponent and play call information on the opponent defense analytic panel 217 and self-scout 219, to facilitate the user in making a selection that is effective and/or in accord with a game plan. Further, in examples, the user interface 220 can list the in-game play calls, with information recorded by the user. The user can scroll, for example, the list 221 to view the sequence of in-game play calls, including permutations, defensive formations, coverage and blitzes and other information.

FIG. 2C illustrates another example user interface 230, according to one or more embodiments. The user interface 230 includes an opponent panel 232, a play call selection feature 234, a situational panel 238, an outcome panel 236A for field position, and an outcome panel 236B for describing the play's termination. With reference to FIG. 1A and FIG. 2C, the opponent panel 232 illustrates another implementation of the opponent panel 112; the play call selection feature 234 illustrates another implementation of the play call panel 214; the outcome panels 236A and 236B illustrate another implementation of the outcome panel 116; and the situational panel 238 illustrates another implementation of the situational panel 118.

The user interface 230 can implement functionality such as described with FIG. 2A and FIG. 2B, except rather than user a number code for selecting/identifying the play call, the user can identify the play-call by selecting the play concept and its various permutations. Each permutation can be pre-populated and provided in a separate column or interactive feature. In the example shown, the user can select a play call by selecting permutations (e.g., personnel alignment (tight ends, running backs), formations, adjustments, motion permutation, blocking permutation, concept etc. The selections can be concatenated into a play call. The user interface 230 230 can implement the play-calling panel 234 through a series of menu selections which can be structured and prepopulated based on the pre-configurations 111. The user can interact with the menu selections to rapidly construct multiple configurations or alignments of an offense, which collectively identify a play for a given down. Additional panels and features (e.g., such as analysis panels 117, 119) can be provided on additional screens.

FIG. 2D illustrates another user interface for game management, according to one or more embodiments. A user interface 250 can be implemented on a user interface device 90 when a user's team is on offense. The user interface 250 includes a plurality of regions that individually serve different purposes, and collectively enable a flow which generally corresponds to a sequence of events which occur during a game when the user's team is on offense. Accordingly, the use of individual panels can be sequenced, to correlate with events as the occur during the game. As described with examples, the user interface 250 can be optimized to facilitate user-input in an in-game scenario. For example, the layout of the user interface can be optimized to minimize a number of interactions from the user.

The user interface 250 can include a field position region 252, a situational panel 254, a play call region 256, a defensive scheme region 258, and an outcome region 240. The individual regions can include multiple user interface elements and features that are optimized for a corresponding purpose of the respective region. As shown and described with examples of FIG. 2A through FIG. 2C, the user interface elements can correspond to, for example, number pads, many selection items, single select options from a multi-option panel, checkboxes, soft buttons and the like.

In a typical offense game scenario, a user can initiate a flow by specifying a field position value with the field position region 252. As shown by FIG. 2A and FIG. 2C, the field position region 252 can include a number pad that enables the user to select a field position value, marking the user's current field position. The field position region 252 can be optimized to enable the user to specify a current field position in a minimal number of taps on the user interface device 90 (e.g., two or three taps).

Following the user entering the field position, situational information can be automatically calculated and displayed in the situational region 254. The situational information can be calculated based on the current field position (as specified by the user through the field position panel 252) and the situational information (if any) before the prior play was run. In examples, the situational information can include the down, distance to first down (and/or touchdown), field position, the quarter of play (or other time information), the series sequence number, and the play sequence number. The situational region 254 can be interactive, to enable the user to override the output, or alternatively specify additional input such as lateral position of the ball marker on the field (e.g., left, middle are center hash).

The play call region 256 can include input elements for enabling the user to specify a play call. In particular, the elements can enable the user to specify a play call of a particular type, concept, utilizing particular personnel, and enabling additional permutations (e.g., formation and adjustments, motion permutation, blocking scheme, etc.). In examples, the play call region 256 can be configured to accommodate different preferences. For example as shown by an example of FIG. 2A, the play call region 256 can include a number pad that enables the user to enter coded numerical sets that designate play calls by concept, formation and permutation(s). Alternatively as shown by an example of FIG. 2C, the play call region 256 can include multiple panels, each of which allow user selection of the particular value from the list of possible values, where each value specifies, for example, a concept, formation or permutation. In other examples, the play call region 256 can include an auto-fill feature the displays facets of offense of play calls based on text entry or other actions of the user. The particular configuration or structure of the play call region 256 can depend on the preference of the user, including the type of play call equipment which the user's team utilizes. For example, some teams prefer wrist devices for players, where the wrist devices enable a coach to communicate play calls to players based on a numeric sequence. In such cases, the play call region 256 can include a number pad for enabling generation of number sequences that designate play calls. Depending on the configuration of the play call region, the user can specify play call in a minimal number of interactions (e.g., 2-5 touches).

The defensive scheme region 258 enables the user to record a defensive scheme of the opponent before and/or during the execution of the play call. In some examples, the defensive scheme region 258 includes multiple panels to enable the user to specify the, for example, formations of the opponent's defense, such as front formation, coverage formation, blitz formation and the like. Each panel can include a list of options from which the user can select, where the options are pre-populated from opponent data collected before the game (e.g., via import or interface to a third-party).

The outcome region 240 enables the user to record one of multiple possible outcomes for each play. For example, the outcome region 260 can designate different outcome options for different play types. For run plays, the outcome region 260 can enable the user to select as outcomes run (e.g., the player execute a running play that resulted in a tactful), a run touchdown, or a loss fumble. For past type place, the outcome options can include complete, incomplete, scramble sack, past touchdown, complete followed by loss fumble, or interception. Still further, the outcome can reflect another type of outcome, such as no play or penalty. As shown with examples, the outcome region 260 can enable the user to identify the outcome with one touch.

Depending on implementation, regions of the user interface 250 can be implemented on one display screen or multiple display screens. Further, each region can be positioned and/or linked with interactive features to promote a sequence in which each region is used. For example, the regions of the user interface 250 can be arranged from left-to-right, or between different screens in a sequence that matches expected events before, during and after execution of the game play.

In examples, the user interface 250 can also include informational regions 262, 264, and 266. The information regions can include analytic information relating to play calls, defensive schemes, and opponent information. For example, the information regions 262, 264, and 266 can display information described with analytics panel 117, 119.

Accordingly, in examples, the analytic information can include in-game analytic information. For example, the analytic information can provide analytics in the form of efficiency determination for play calls and defensive schemes of the user's teams, as well as against opponents defensive schemes or offensive play call selections. The efficiency determination can be based on an outcome after a play call execution, where the definition of efficiency is predetermined. For example, an efficient play call can be one that (i) if called on first down, gains 4 or more yards; (ii) if called on another down, achieves a first down greater than 10 yards, or half of the distance to the first down marker; (iii) for third or fourth downs, converts to a first down or to a touchdown. The user can specify variations or configurations for the determination of efficiency. In examples, one or more of the information regions 262, 264, 266 can display an efficiency for play calls of the user based on outcomes of those play calls in the current game. As an addition or alternative, the efficiency for play calls can extend to prior games. As an addition or variation, the information regions 262, 264, 266 can include aggregations of play calls or defensive schemes for the user's team or the opponents. For example, an informational region 262, 264, 266 can include the number of instances a particular offensive play call or defensive scheme was called in the game, for either or both the opponent's team or the opponent. The user can use such information to identify a tendency of the opponent, or identify instances when the user's play call or scheme selection is over-used (and thus predictable). Still further, one or more information regions 262, 264, 266 can identify a list of predetermined (e.g., as specified by user input) play calls, such as a list of preferred play calls which the user intends to call the most often, or in specific situation. In examples, the efficiency, instances of use, prediction of use (e.g., for opponent) can be calculated during the game and displayed in real-time on the information regions.

In examples, the one or more of the information panels can also include recommendation data sets 165, which may be generated by the recommendation engine 150 (see FIG. 1B). As described, the recommendation sets 165 can recommend play calls and/or defensive schemes, with additional analytics that indicate, for example, an efficiency the recommended play call or scheme selection (e.g., based on prior plays) and/or an expected outcome of the play call or scheme selection.

In examples, one or more of the information regions 262, 264 can include a panel 266 that is dynamic. In examples, the panel 266 is floating (e.g., an overlay) and dynamic in position, meaning the panel 266 can be moved over the user interface 250 (or a portion thereof). As an addition or variation, the panel 266 can be dynamic as to when it is displayed. For example, the user interface component 110 can generate the panel 266 in response to the occurrence of a condition (e.g., when the user's team is determined to obtain possession of the ball).

As an addition or variation, information provided on the panel 266 can be dynamic and responsive to real-time events which occur during the game. For example, after an outcome of a play call is recorded, an efficiency and/or value associated with a recommendation of the particular play call can be changed automatically to account for the particular outcome.

### Methodology

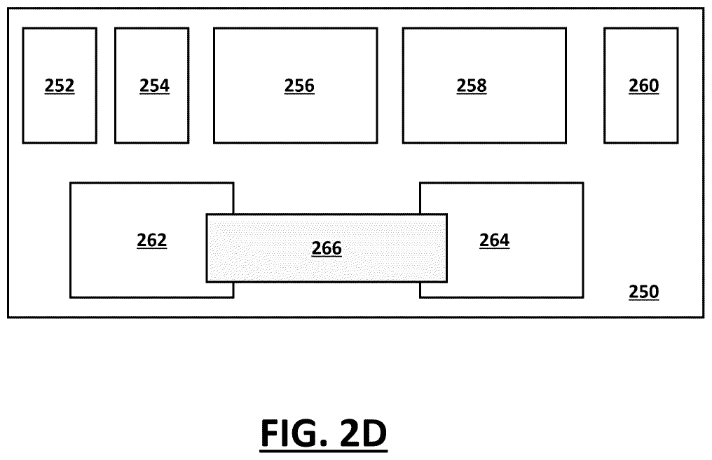

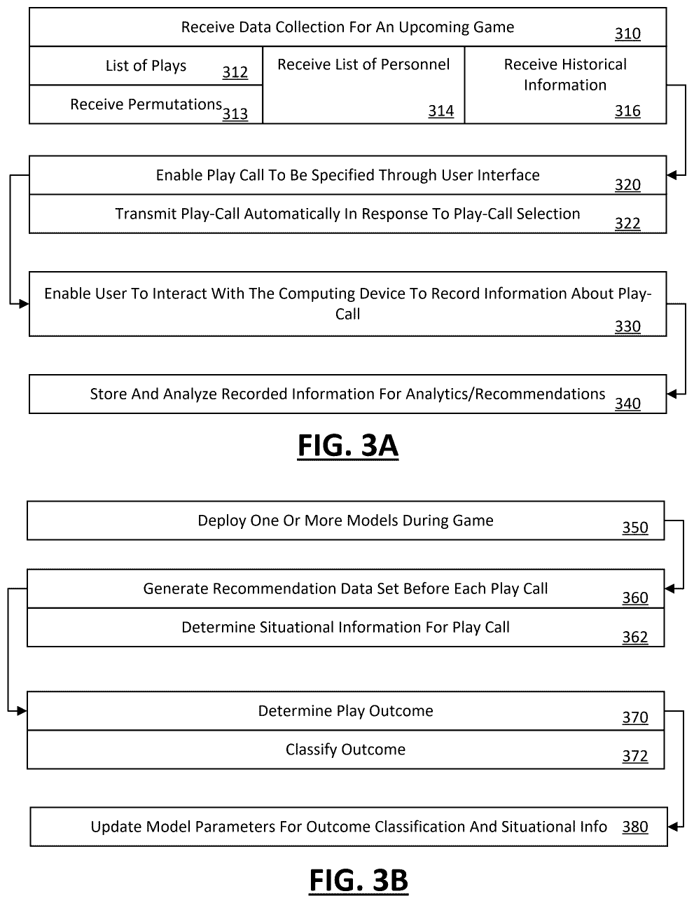

FIG. 3A illustrates a method for using a game management system during the course of a game, according to one or more embodiments. A method such as described with an example of FIG. 3 can be implemented using a game management system such as described with FIG. 1A, as well as user interface features such as described with FIG. 2A through FIG. 2C. Accordingly, reference may be made to FIG. 1A and FIG. 2A through FIG. 2C for purpose of illustration.

In step 310, the computing device receives a data collection for a given opponent or game. In step 312, the data collection can include a list of plays which the team may run during a game. The plays can include an identifier, such as a name identifier (e.g., “wide-cross double-go”) or numeric identifier (e.g., “110”). In examples, the identifier of the play can correspond to a concept. The list of plays can also include possible permutations reflecting personnel, player formation before the play starts (e.g., “formation column”), adjustments to left or right side of the ball location, type of motion that may accompany the play (e.g., before ball is moved, an offensive player changes position), blocking scheme, and other permutations. The possible permutations can be provided as separate lists too a list of play concepts or identifiers. As an addition or variation, the permutations can be determined from the list of plays. Thus, for example, the list of plays can include or identify permutations. In the latter case, the user interface device 90 can scan the play list and identify one or more types of permutations. The list of permutations can then be used to pre-populate the play-call panels 114 (e.g., see FIG. 2C).

In some examples, in step 313, the list of play-calls may be mapped to a code, such as a 3 digit numeric identifier, where the numeric identifier identifies the concept and one or more permutations. The code mapping can be generated by the system 100. Alternatively, the code mapping can be provided to the system 100 as input.

In step 314, the user interface device 90 receives a list of personnel for the game. The personnel can be provided for the team (e.g., roster). In examples, the system 100 pre-populates personnel selection feature 219 (see FIG. 2C) using the names of the offensive players for the team.

In step 316, the user interface device 90 receives historical information regarding the opponent's defense. The opponent historical information can include information from prior games of the opponent, including the opponent formation uses, the context (e.g., down, distance and yardage) in which the formation was used, and/or the result of the play against the opponent's formation.

In some examples, the user interface device 90 can also receive historical information about the user's team, including offensive play calls (e.g., play concept and permutations) and results (e.g., yards gained when play was run).

During game time, the computing device may perform steps 320-340. In step 320, the computing device is operated to specify play-calls-where each play call reflects how a play is to be executed on the field. With reference to FIG. 2A, when the user's team starts a first offensive sequence, the user interacts with the user interface device 90 to enter their field position. The user can interact with a field position feature, such as by operating a number pad to specify the field position (2-3 touches). Alternatively, the user can operate a slider (e.g., one interaction), or use voice input to specify the initial field position (1-2 interactions). The user can then interact with the play calling panel 114 to specify a play call, where the play can identify the concept and the hashmark. The user can utilize a numeric code to identify the play-call (3 touches/interactions). Alternatively, the user can specify the name of the play-call (e.g., concept name and one or more permutations), and the computing device can translate the utterance into a 3 digit code (1 interaction). The user can also specify the hashmark position (1 touch/interaction).

In some examples, in step 322, the play-call is transmitted to the field automatically and in response to the selection being made. For example, the system 100 may utilize a wireless receiver of the computing device to transmit a play-call to an on-the-field coach or player personnel. Among other advantages, embodiments such as described optimize the user interface to enable the user to specify play calls more quickly than conventional methods. In this way, for example, a team can more readily run a fast-paced offense (e.g., “no huddle”).

In step 330, the user can interact with the computing device to record information about the play-call. The information can include information about the offensive personnel that executed the play. The user can interact with the personnel selection feature 219 (see FIG. 2B and FIG. 2C) to select the personnel that were included in the play's execution (1-2 user touches/interactions). The recorded information can also include information about the defensive scheme that is used. The user can interact with the opponent panel 212 (see FIG. 2B and FIG. 2C) to specify the defensive scheme by characteristics (e.g., defensive front personnel formation, defensive back personnel formation, blitz scheme) (1-3 touches/interactions). Additionally, the recorded information can include information about the outcome of the play-call. The user can interact with the outcome panel 218 to specify the outcome of the play. The outcome can be specified by selection (1 touch/interaction), and the user can return to specifying the field position, after which the game management system 100 can calculate the yardage gain of the play.

In step 340, the recorded information can be stored and analyzed by, for example, the game module 120 (FIG. 1) and/or the opponent module. For example, the recorded information can be stored in the game data store 125, where the data is analyzed by the game module 120 and/or the opponent module 130. As described with some examples, the analysis performed by the game module 120 and/or the opponent module 130 can include an aggregate or statistical analysis. The statistical and other analytical information that is determined by the gaming module 120 can be used to provide information as part of the self-scout panel 119, 219 (FIG. 2A) information. Additionally, statistical and other analytical information that is determined by the opponent module 130 can be used to provide information for the opponent panel 112, 212.

As illustrated by examples of FIG. 2A-FIG. 2C and FIG. 3, the user interfaces 210, 220, 230 which can be generate by the game management system 100 can be optimized for game play, where decisions have to be made quickly (e.g., between 5-15 seconds), as well as recorded information about the play calls (e.g., outcomes, defensive formations, coverage and blitzes, etc.). Embodiments as described minimize the number of touches (via touch screen) or interactions (via microphone) the user is required to make to enter the requisite information for selecting plays (play calling) and/or recording in-game information about play calls. For example, at the sophistication of the collegiate level, the user can enter requisite information as shown with FIG. 2A and FIG. 2B, or FIG. 2C, with 9-18 touches, and in many cases between 9-12 touches. The second saved can be invaluable for play calling, such as in scenarios where the user's team plays up-tempo. Additionally, by enabling the user to thoroughly record information about play calls during the game, the game management system 100 is able to more accurately analyze the defensive information, to provide the quality of the opponent defensive analytical information. Likewise, the system is also able to provide more accurate and thorough analysis for the self-scout information (e.g., see FIG. 2A). FIG. 3B illustrates an example method for generating a recommended data set that identifies play calls and/or defensive schemes in context of a game, according to one or more examples.

With reference to FIG. 3B, in step 350, the recommendation engine 150 can deploy one or more models during the game. The deployed models can include one or more models for recommending play calls for the user (when the user's team is on offense) and/or defensive schemes (when the user's team is on defense). In some examples, the deployed models can also include models that predict the opponents defensive scheme (when the user's team is on offense) and/or the opponent's offense of play calls (when the user's team is on defense). Still further, in examples, the deployed models also include one or more models that predict an outcome for each recommended play call and or defensive scheme.

In step 360, the recommendation engine 150 uses the deployed models to generate recommended data sets 165 for an upcoming play, where the recommended data set 165 identifies (i) one or more play calls (when the user's team is on offense), (ii) defensive schemes (when the user's team is on defense), and optionally (iii) predicted outcomes for the selected play call or defensive scheme. In generating recommend data sets, in step 362, the recommendation engine 150 identifies as input, situational information (e.g., down, yardage, field position, time, etc.), which can be determined from user input recorded with the game data store 125.

In step 370, the outcome of the play is determined. In determining the outcome, the recommendation engine 150 can also determine from the game data store which play call or defensive scheme the user selected. In step 372, the outcome can be classified, or otherwise associated with attributes that reflect whether the play met one or more objectives (e.g., obtain a designated amount of yardage, obtain a first down, score, etc.), and to what degree a given objective was met. The particular play which was run, where the recommended or not, to be identified from the play call or defensive scheme list. The determined classification for the outcome of the particular play call art defensive scheme can be associated with the play call or defensive scheme in the list.

In step 380, the recommendation engine 150 can compare the classification of the outcome for the play call or defensive scheme with the predicted outcome for the same play call defensive scheme. Based on the comparison, the recommendation engine 150 can update the models deployed during the game.

### Hardware Diagram

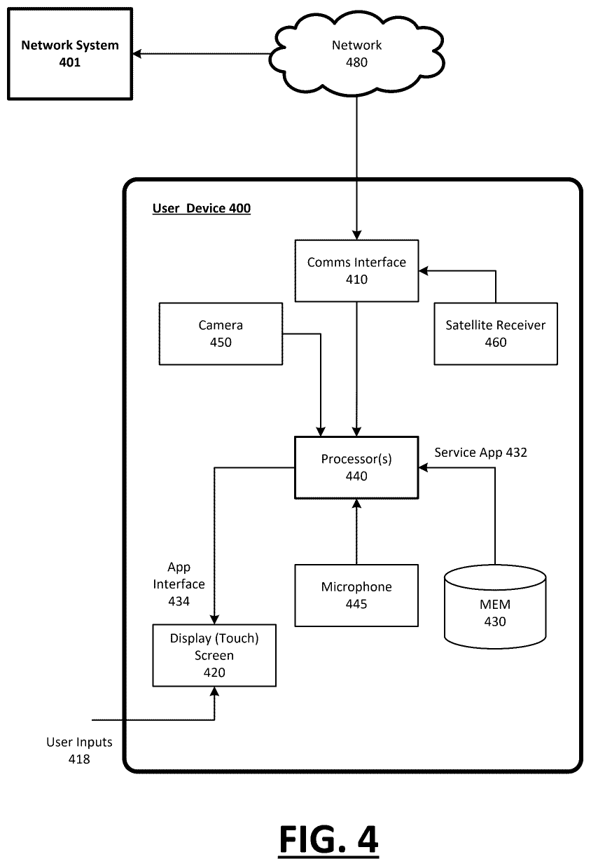

FIG. 4 illustrates a computing device or system on which one or more embodiments can be implemented. In an example, the computing device corresponds to a user device 400, such as mobile device (e.g., tablet). The user device 400 can execute a game management application 432 on which game management system 100 is implemented, as described with examples of FIG. 1A and FIG. 2A through FIG. 2C. Additionally, the user device 400 can implement methods such as described with examples of FIG. 3. In many implementations, a user device 400 can include a mobile computing device having a touch-sensitive display or input surface, such as a tablet computer or computer that can be held in one or two hands. In variations, the computer device includes a laptop, VR or AR headset device, and the like.

The user device 400 includes one or more processors 440 and memory resources 430. The memory resources 430 stores instructions that can correspond to service application 432. The processor(s) 440 execute the instructions of the service application 432 generate an application interface 434. The application interface 434 can correspond to user interface component 110, and may be rendered via the display screen 420. Additionally, the computing device 400 includes a microphone 445, a camera 450, a satellite receiver 460, and/or a wireless communication interface 410.

The display screen 420 can receive user inputs, such as described with examples of FIG. 2A through FIG. 2C. The microphone 445 can be used in connection with a voice transcription tool which can translate voice utterances into inputs 418 received through the user interface component 110. The game management system 100 can include a voice transcription component that can translate voice utterances into input. Alternatively, the game management system 100 can include an interface to a voice transcription service that is provided with, for example, a third-party application or service that is resident on the computing device 400. The user device 400 can execute game management application 432 and implement functionality as described to generate, for example, the user interface component 110 on the display 420. In certain aspects, the user device 400 can store a designated application (e.g., a game management app 432) in a local memory 430.

When the game management application 432 is executed, the user can interact with the user interface component 110 (see FIG. 1) to provide input corresponding to game management operations. The application 432 generates output as described with various examples. In some examples, the user can interact with the executing application 432 by providing touch input (via the display screen 420). As an addition or variation, the computing device 400 utilizes the microphone 445 to receive voice input, which the processor 440 recognizes and interprets as input.

### Conclusion

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

1. A user interface device for game management, the user interface device including
one or more processors;
memory to store instructions;
wherein the one or more processors execute instructions stored in memory to perform operations comprising:
generating, for a user managing a user's team during a course of a game, a user interface that includes a plurality of regions, the plurality of regions including one or more regions to enable a user to specify one of a play call or a scheme;
wherein the user interface includes a dynamic panel that overlays one or more of the plurality of regions, the dynamic panel displaying team-specific analytic information that is updated responsively to game events that affect the analytic information.

2. The user interface device of claim 1, wherein the dynamic panel is moveable as an overlay of the user interface.

3. The user interface device of claim 1, wherein the operations further comprise:
generating recommendation output on the dynamic panel, the recommendation output identifying one or more of a candidate set of play calls or defensive schemes for the user's team to run for a next or upcoming play.

4. The user interface device of claim 3, wherein the operations further comprise:
developing one or more models for selecting, from a library of play calls or defensive schemes, an optimal set of play calls or defensive schemes for the user's team to run for one or more subsequent plays during a game, wherein the one or more models are developed based on historical information including historical information about play calls and/or defensive schemes that the user's team used in prior games, including outcomes of the play calls and/or defensive schemes and situational information when the play calls and/or defensive schemes were used; and
wherein generating the recommendation output is based at least in part on deploying the one or more models during the game.

5. The user interface device of claim 4, wherein the operations further comprise:
developing one or more models for predicting a play call or defensive scheme for an opponent to run for one or more subsequent plays during a game, wherein the one or more models are developed based on historical information including historical information about play calls and/or defensive schemes that the opponent's team used in prior games, including a number of instances a play call or defensive scheme was used and situational information for when the opposing team used the play calls and/or defensive schemes; and
wherein generating the recommendation output is based at least in part on predicting the opponent's play call or defensive scheme for a next or upcoming play.

6. The user interface device of claim 4, wherein the operations further comprise:
determining an outcome of a selected play call or defensive scheme; and
updating, during the game and in response to determining the outcome, at least one of the one or more models based on the determined outcome.

7. The user interface device of claim 6, wherein the operations further comprise:
executing one or more updated models to update the candidate set of play calls or defensive schemes, and dynamically changing the candidate set of play calls or defensive schemes on the dynamic panel.

8. The user interface device of claim 6, wherein determining the outcome of the selected play includes determining whether the execution of the play call during the game resulted in an efficient outcome.

9. The user interface device of claim 4, wherein the one or more models include stochastic machine-learning models.

10. The user interface device of claim 4, wherein the one or more models include situational specific models, and wherein the operations further comprise selecting one or more models for a next or upcoming play or series of plays based on a current situational information.

11. A non-transitory computer-readable medium that stores instructions, which when executed by one or more processors, cause the one or more processors to perform operations comprising:
generating, for a user managing a user's team during a course of a game, a user interface that includes a plurality of regions, the plurality of regions including one or more regions to enable a user to specify one of a play call or a scheme;
wherein the user interface includes a dynamic panel that overlays one or more of the plurality of regions, the dynamic panel displaying team-specific analytic information that is updated responsively to game events that affect the analytic information; and
generating recommendation output on the dynamic panel, the recommendation output identifying one or more of a candidate set of play calls or defensive schemes.

12. The non-transitory computer-readable medium of claim 11, wherein the dynamic panel is moveable as an overlay of the user interface.

13. The non-transitory computer-readable medium of claim 11, wherein the operations further comprise:
developing one or more models for selecting, from a library of play calls or defensive schemes, an optimal set of play calls or defensive schemes for the user's team to run for one or more subsequent plays during a game, wherein the one or more models are developed based on historical information including historical information about play calls and/or defensive schemes that the user's team used in prior games, including outcomes of the play calls and/or defensive schemes and situational information when the play calls and/or defensive schemes were used; and
wherein generating the recommendation output is based at least in part on deploying the one or more models during the game.

14. The user interface device of claim 13, wherein the operations further comprise:
developing one or more models for predicting a play call or defensive scheme for an opponent to run for one or more subsequent plays during a game, wherein the one or more models are developed based on historical information including historical information about play calls and/or defensive schemes that the opponent's team used in prior games, including a number of instances a play call or defensive scheme was used and situational information for when the opposing team used the play calls and/or defensive schemes; and
wherein generating the recommendation output is based at least in part on predicting the opponent's play call or defensive scheme for a next or upcoming play.

15. The non-transitory computer-readable medium of claim 13, wherein the operations further comprise:
determining an outcome of a selected play call or defensive scheme; and
updating, during the game and in response to determining the outcome, at least one of the one or more models based on the determined outcome.

16. The non-transitory computer-readable medium of claim 15, wherein the operations further comprise:
executing one or more updated models to update the candidate set of play calls or defensive schemes, and dynamically changing the candidate set of play calls or defensive schemes on the dynamic panel.

17. The non-transitory computer-readable medium of claim 15, wherein determining the outcome of the selected play includes determining whether the execution of the play call during the game resulted in an efficient outcome.

18. The non-transitory computer-readable medium of 13, wherein the one or more models include stochastic machine-learning models.

19. The non-transitory computer-readable medium of 13, wherein the one or more models include situational specific models, and wherein the operations further comprise selecting one or more models for a next or upcoming play or series of plays based on a current situational information.

20. A computer-implemented method for using a user interface device, the method comprising:
generating, for a user managing a user's team during a course of a game, a user interface that includes a plurality of regions, the plurality of regions including one or more regions to enable a user to specify one of a play call or a scheme; wherein the user interface includes a dynamic panel that overlays one or more of the plurality of regions, the dynamic panel displaying team-specific analytic information that is updated responsively to game events that affect the analytic information; and
generating recommendation output on the dynamic panel, the recommendation output identifying one or more of a candidate set of play calls or defensive schemes.
